(19) United States
(12) Patent Application Publication
(10) Pub. No.: US 2020/0282909 A1
(43) Pub. Date: Sep. 10, 2020

(54) VEHICLE IMAGING SYSTEM AND METHOD FOR A PARKING SOLUTION

(71) Applicant: GM GLOBAL TECHNOLOGY OPERATIONS LLC, Detroit, MI (US)

(72) Inventors: Nicky Zimmerman, Ramat Hasharon (IL); Yael Shmueli Friedland, Tel Aviv (IL); Michael Slutsky, Kfar Saba (IL)

(21) Appl. No.: 16/295,911

(22) Filed: Mar. 7, 2019

(51) Int. Cl. B60R 1/00

(52) U.S. Cl. CPC B60R 1/00; B60R 2300/806; B60R 2300/105; B60R 2300/303; B60R 2300/304; B60R 2300/602

(57) ABSTRACT

A vehicle imaging system and method for providing a user with an easy to use vehicle parking solution that displays an integrated and intuitive backup camera view, such as a first-person composite camera view. The first-person composite camera view may include composite image data from a plurality of cameras mounted around the vehicle that has been joined or stitched together, as well as augmented graphics with computer-generated simulations of parts of the vehicle that provide the user with intuitive information concerning the point-of-view being displayed. The point-of-view of the first-person composite camera view is that of an observer located within the vehicle, and is designed to emulate the point-of-view of a driver. It is also possible to provide a direction indicator that allows the user to engage a touch screen display and manually change the direction of the first-person composite camera view so that the user can intuitively explore the vehicle surroundings.

### TECHNICAL FIELD

The exemplary embodiments described herein generally relate to a system and method for use in a vehicle and, more particularly, to vehicle imaging system and method that provide a user with an integrated and intuitive parking solution.

### INTRODUCTION

The present disclosure relates to parking solutions for a vehicle, namely, to vehicle imaging systems and methods that display integrated and intuitive backup camera views to assist a driver when backing up or parking the vehicle.

Vehicles currently come equipped with a variety of sensors and cameras and use this equipment to provide parking solutions, some of which are based on isolated camera views or holistic camera views. For those parking solutions that only provide an isolated camera view (e.g., only a rear, side, fish-eye perspective, etc.), the visible field-of-view provided to the driver is probably smaller than an integrated view, where multiple camera perspectives are integrated or otherwise joined together on a single display. As for holistic camera views, such as those integrating multiple camera perspectives into a single bowl view or 360° view, there can be issues regarding the usability of such parking solutions, as they are oftentimes non-intuitive or they display images that are partially blocked or occluded by the vehicle itself.

Thus, it may be desirable to provide an imaging system and/or method as part of a vehicle parking solution that displays an integrated and intuitive backup camera view that is easy to use, such as a first-person composite camera view.

### SUMMARY

According to one aspect, there is provided a vehicle imaging method for use with a vehicle imaging system, the vehicle imaging method comprising the steps of: obtaining image data from a plurality of vehicle cameras; generating a first-person composite camera view based on the image data from the plurality of vehicle cameras, the first-person composite camera view is formed by combining the image data from the plurality of vehicle cameras and presenting the combined image data from a point-of-view of an observer located within the vehicle; and displaying the first-person composite camera view on a vehicle display.

According to various embodiments, the vehicle imaging method may further include any one of the following features or any technically-feasible combination of some or all of these features:
the generating step further comprises generating the first-person composite camera view that includes augmented graphics combined with composite image data;
the augmented graphics include computer-generated representations of portions of the vehicle that would normally be seen by the observer located within the vehicle if the observer was looking out of the vehicle in a particular direction, the composite image data includes the combined image data from the plurality of vehicle cameras, and the augmented graphics are superimposed on the composite image data;
the computer-generated representations of portions of the vehicle are electronically associated with a particular object or location within the first-person composite camera view so that, when the particular direction of the perspective of the observer is changed, the augmented graphics change as well so that they appear to naturally move along with the changing composite image data;
when the first-person composite camera view is a rearward facing view, the augmented graphics include computer-generated representations of a portion of a vehicle trunk lid, of a portion of a vehicle rear window frame, or both;
the generating step further comprises presenting the combined image data from a substantially stationary point-of-view of the observer located within the vehicle, the substantially stationary point-of-view is still located within the vehicle even when a direction of the first-person camera view is changed;
the generating step further comprises generating the first-person composite camera view so that a user has a 360° view around the vehicle;
the generating step further comprises generating the first-person composite camera view in response to a camera view control input;
the generating step further comprises building a projection manifold on which the first-person composite camera view can be displayed, and the projection manifold is a virtual object that is at least partially defined by a camera plane, a camera ellipse, and a point-of-view of the observer located within the vehicle;
the camera plane is a virtual plane corresponding to the locations of the plurality of vehicle cameras, and for each of the plurality of vehicle cameras, the camera plane either passes through an actual location of the vehicle camera or an effective location of the vehicle camera;
the camera ellipse is a virtual ellipse corresponding to the locations of the plurality of vehicle cameras and being coplanar with the camera plane, and for each of the plurality of vehicle cameras, the camera ellipse either passes through an actual location of the vehicle camera or an effective location of the vehicle camera;
the location of the point-of-view of the observer is on the camera plane and is within the camera ellipse;
the location of the point-of-view of the observer corresponds to an intersection of a plurality of projecting lines, and each of the plurality of projecting lines is perpendicular to a line tangent to a perimeter of the camera ellipse at the actual location of the vehicle camera or the effective location of the vehicle camera;
the location of the point-of-view of the observer is above or below the camera plane, is within the camera ellipse, and corresponds to an apex of a pseudo-conical surface that includes the camera ellipse along a flat base;
the generating step further comprises transforming the image data from the plurality of vehicle cameras to a corresponding frame-of-reference of the projection manifold;
the generating step further comprises rectifying the transformed image data along a local tangent of the camera ellipse;
the generating step further comprises stitching together the transformed-rectified image data to form the composite camera view;
the displaying step further comprises displaying the first-person composite camera view on a first portion of the vehicle display and a direction indicator on a second portion of the vehicle display, the direction indicator enables a user to manually engage or control certain aspects of the first-person composite camera view; and
the direction indicator is superimposed on a virtual vehicle and is displayed a touch-screen that is part of the second portion of the vehicle display, the direction indicator is electronically linked to the first-person composite camera view such that when the user manually engages the direction indicator via the touch screen, a direction of the first-person composite camera view changes accordingly.

According to another aspect, there is provided a vehicle imaging system, comprising: a plurality of vehicle cameras that provide image data; a vehicle video processing module coupled to the plurality of vehicle cameras, wherein the vehicle video processing module is configured to generate a first-person composite camera view based on the image data from the plurality of vehicle cameras, the first-person composite camera view is formed by combining the image data from the plurality of vehicle cameras and presenting the combined image data from a point-of-view of an observer located within the vehicle; and a vehicle display coupled to the vehicle video processing module for displaying the first-person composite camera view.

### BRIEF DESCRIPTION OF THE DRAWINGS

One or more embodiments of the disclosure will hereinafter be described in conjunction with the appended drawings, wherein like designations denote like elements, and wherein:

FIG. 1 is a block diagram depicting a vehicle with an embodiment of a vehicle imaging system that helps provide a vehicle parking solution;

FIG. 2 is a perspective view of the vehicle of FIG. 1 along with mounting locations for a plurality of cameras;

FIG. 3 is a top or plan view of the vehicle of FIG. 1 along with the mounting locations for the plurality of cameras;

FIG. 4 depicts a vehicle display showing an embodiment of an integrated and intuitive backup camera view, namely a first-person composite camera view;

FIG. 5A illustrates a known holistic camera view, namely a bowl view or third-person camera view that is taken from a perspective in which the observer (P) is located in front of the vehicle and is looking towards a rear of the vehicle;

FIG. 5B illustrates the holistic camera view of FIG. 5A, except the observer (P) is located behind the vehicle and is looking towards a front of the vehicle;

FIG. 6A illustrates an embodiment of a first-person composite camera view that is taken from a perspective in which the observer (P) is located inside of the vehicle and is looking towards a rear of the vehicle;

FIG. 6B illustrates the first-person composite camera view of FIG. 6A, except that the observer is located inside of the vehicle and is looking towards a front of the vehicle;

FIG. 7 is a flowchart depicting an embodiment of a vehicle imaging method for displaying an integrated and intuitive backup camera view;

FIG. 8 is a flowchart depicting an embodiment of a first-person composite camera view generation process that can be carried out as a part of the method of FIG. 7; and

FIG. 9 is a perspective view of a camera ellipse that resides in the camera plane and that illustrates technical features of the first-person composite camera view generation process of FIG. 8.

### DETAILED DESCRIPTION

The vehicle imaging system and method described herein provide a driver with an easy to use vehicle parking solution that displays an integrated and intuitive backup camera view, such as a first-person composite camera view. The first-person composite camera view may include image data from a plurality of cameras mounted around the vehicle that are blended, combined and/or otherwise joined together (hence the “integrated” or “composite” aspect of the camera view). The point-of-view or frame-of-reference of the first-person composite camera view is that of an observer located within the vehicle, as opposed to one located outside of the vehicle, and is designed to emulate the point-of-view of the driver (hence the “intuitive” or “first-person” aspect of the camera view). Some conventional vehicle imaging systems use image data from only a single camera as part of a parking solution, and are referred to here as isolated camera views. Whereas other conventional vehicle imaging systems join image data from a plurality of cameras, but display the images as third-person camera views that are from the point-of-view of an observer located outside of the vehicle; these views are referred to here as holistic camera views. In some holistic camera views where the observer located outside of the vehicle is looking through the vehicle towards the intended target area, the vehicle itself can undesirably obstruct or occlude portions of the target area. Thus, by providing a vehicle parking solution that utilizes a first-person composite camera view, the vehicle imaging system and method described herein can show the driver a wide view of the area surrounding the vehicle, yet still do so from an unobstructed and intuitive perspective that the driver will naturally understand.

In one embodiment, the first-person composite camera view includes augmented graphics that are overlaid or otherwise added to composite image data. The augmented graphics can include computer-generated simulations of parts of the vehicle that are designed to provide the driver with intuitive information concerning the point-of-view or frame-of-reference of the view being displayed. As an example, when the vehicle is a passenger car and the first person composite camera view is of a target area located behind the vehicle, the augmented graphics can simulate a portion of the rear window or vehicle trunk lid so that it appears as if the driver is actually looking out the rear window. In a different example where the first person composite camera view is of a target area on the side of the vehicle, the augmented graphics may simulate a portion of an A- or B-pillar of the passenger car so that the image appears as if the driver is actually looking out a side window. In the preceding examples, the augmented graphics may change with a change in the target area, so as to mimic a camera that is being panned. In another embodiment, the vehicle parking solution is provided with a direction indicator that allows a user to engage a touch screen display and manually change the direction or other aspects of the first-person composite camera view. This enables the driver to intuitively explore the vehicle surroundings with the vehicle imaging system. Other features, embodiments, examples, etc. are certainly possible.

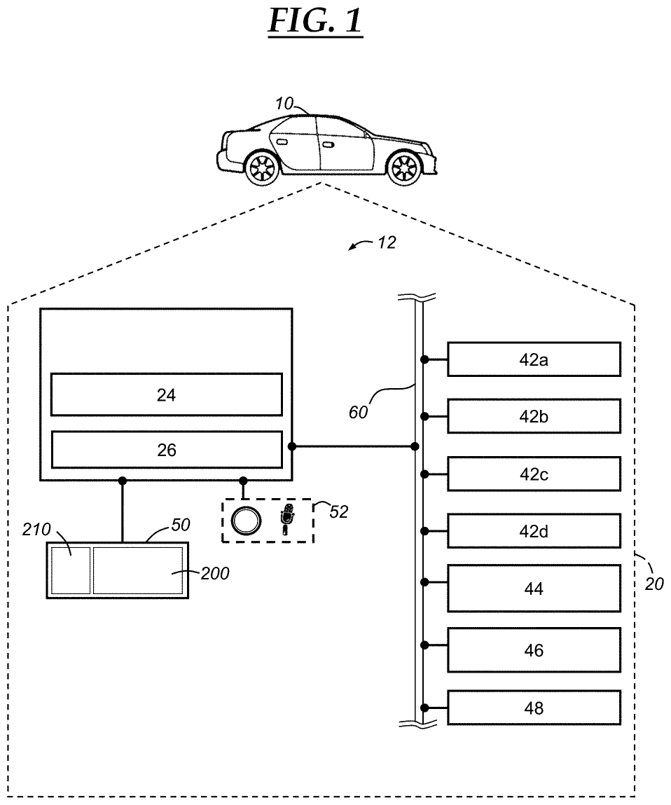

With reference to FIG. 1, there is shown a vehicle 10 with a non-limiting example of a vehicle imaging system 12. The vehicle imaging system 12 may provide the driver with a first-person composite camera view and has vehicle electronics 20 that include a vehicle video processing module 22, a plurality of vehicle cameras 42, a plurality of vehicle sensors 44-48, a vehicle display 50, and a plurality of vehicle user interfaces 52. The vehicle imaging system 12 may include other components, devices, units, modules and/or other parts, as the exemplary system 12 is but one example. Skilled artisans will appreciate that the schematic block diagram in FIG. 1 is simply meant to illustrate some of the more relevant hardware components used with the present method and it is not meant to be an exact or exhaustive representation of the vehicle hardware that would typically be found on such a vehicle. Furthermore, the structure or architecture of the vehicle imaging system 12 may vary substantially from that illustrated in FIG. 1. Thus, because of the countless number of potential arrangements and for the sake of brevity and clarity, the vehicle electronics 20 is described in conjunction with the illustrated embodiment of FIG. 1, but it should be appreciated that the present system and method are not limited to such.

The vehicle 10 is depicted in the illustrated embodiment as a passenger car, but it should be appreciated that any other vehicle including motorcycles, trucks, sports utility vehicles (SUVs), cross-over vehicles, recreational vehicles (RVs), tractor trailers, and even boats and other water- or maritime-vehicles, etc., can also be used. Portions of the vehicle electronics 20 are shown generally in FIG. 1 and include the vehicle video processing module 22, the plurality of vehicle cameras 42, the plurality of vehicle sensors 44-48, the vehicle display 50, and the vehicle user interfaces 52. Some or all of the vehicle electronics 20 may be connected for wired or wireless communication with each other via one or more communication busses or networks, such as communications bus 60. The communications bus 60 provides the vehicle electronics 20 with network connections using one or more network protocols and can use a serial data communication architecture. Examples of suitable network connections include a controller area network (CAN), a media oriented system transfer (MOST), a local interconnection network (LIN), a local area network (LAN), and other appropriate connections such as Ethernet or others that conform with known ISO, SAE, and IEEE standards and specifications, to name but a few. Although most of the components of the vehicle electronics 20 are shown as stand-alone components in FIG. 1, it should be appreciated that components 22, 42, 44, 46, 48, 50 and/or 52 may be integrated, combined and/or otherwise shared with other vehicle components (e.g., the vehicle video processing module 22 could be part of a larger vehicle infotainment or safety system) and are not limited to the schematic representations in that drawing.

Vehicle video processing module 22 is a vehicle module or unit that is designed to receive image data from the plurality of vehicle cameras 42, process the image data, and provide an integrated and intuitive back-up camera view to the vehicle display 50 so that it can be used by the driver as part of a vehicle parking solution. According to one example, the vehicle video processing module 22 includes a processor 24 and memory 26, where the processor is configured to execute computer instructions that carry out one or more step(s) of the vehicle imaging method discussed below. The computer instructions can be embodied in one or more computer programs or products that are stored in memory 26, in other memory devices of the vehicle electronics 20, or in a combination thereof. In one embodiment, the vehicle video processing module 22 includes a graphics processing unit (GPU), a graphics accelerator and/or a graphics card. In other embodiments, the vehicle video processing module 22 includes multiple processors, including one or more general purpose processor(s) or central processing unit(s), as well as one or more GPU(s), graphics accelerator(s) and/or graphics card(s). The vehicle video processing module 22 may be directly coupled (as shown) or indirectly coupled (e.g., via communications bus 60) to the vehicle display 50 and/or other vehicle user interfaces 52.

Vehicle cameras 42 are located around the vehicle at different locations and are configured to provide the vehicle imaging system 12 with image data that can be used to provide a first-person composite camera view of the vehicle surroundings. Each of the vehicle cameras 42 can be used to capture images, videos, and/or other information pertaining to light—this information is referred to herein as “image data”—and can be any suitable camera type. Each of the vehicle cameras 42 may be a charge coupled device (CCD), a complementary metal oxide semiconductor (CMOS) device and/or some other type of camera device, and may have a suitable lens for its location and purpose. According to one non-limiting example, each of the vehicle cameras 42 is a CMOS camera with a fish-eye lens that captures an image having a wide field-of-view (FOV) (e.g., 150°-210°) and provides depth and/or range information for certain objects within the image. Each of the cameras 42 may include a processor and/or memory in the camera itself, or have such hardware be part of a larger module or unit. For instance, each of the vehicle cameras 42 may include processing and memory resources, such as a frame grabber that captures individual still frames from an analog video signal or a digital video stream. In a different example, instead of being included within the individual vehicle cameras 42, one or more frame grabbers may be part of the vehicle video processing module 22 (e.g., module 22 may include a separate frame grabber for each vehicle camera 42). The frame grabber(s) can be analog frame grabbers or digital frame grabbers, and may include other types of image processing capabilities as well. Some examples of potential features that may be used with one or more of cameras 42 include: infrared LEDs for night vision; wide angle or fish eye lenses; stereoscopic cameras with or without multiple camera elements; surface mount, flush mount, or side mount cameras; single or multiple cameras; cameras integrated into tail lights, brake lights, license plate areas, side view mirrors, front grilles, or other components around the vehicle; and wired or wireless cameras, to cite a few possibilities. In one embodiment, depth and/or range information provided by cameras 42 is used to generate the first-person composite camera view, as will be discussed in more detail below.

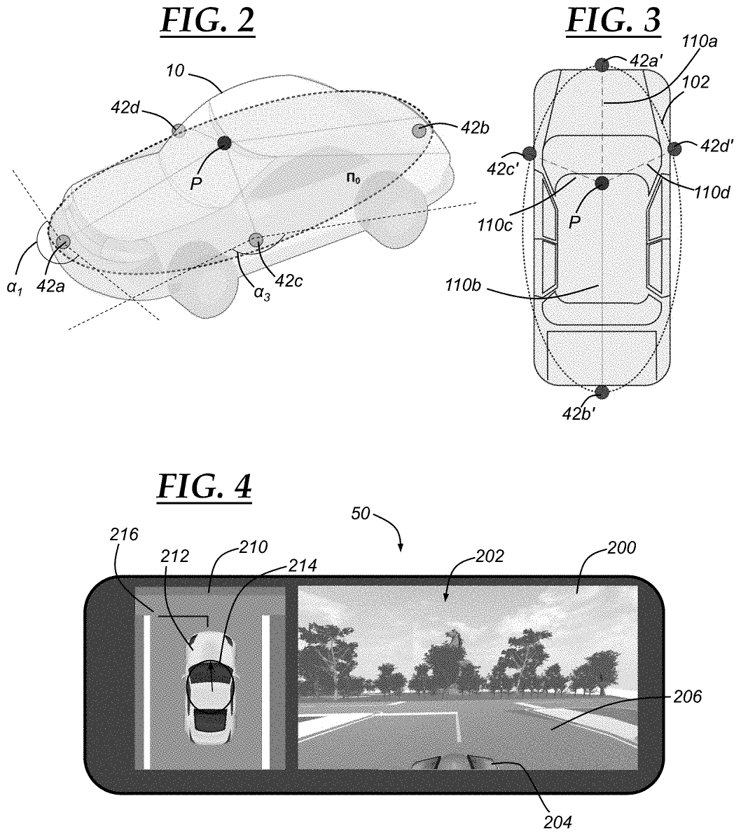

FIGS. 2 and 3 illustrate a vehicle imaging system having four cameras, which include a front (or first) camera 42a, a rear (or second) camera 42b, a left (or third) camera 42c, and a right (or fourth) camera 42d. It should be appreciated, however, that the vehicle imaging system 12 can include any number of cameras, including more or less cameras than shown here. With reference to FIG. 2, the front camera 42a is mounted on the front of the vehicle 10 and faces a target area in front of the vehicle; the rear camera 42b is mounted on the rear of the vehicle and faces a target area behind the vehicle; the left camera 42c is mounted on the left side of the vehicle and faces a target area to the left of the vehicle (i.e., on the driver side); and the right camera 42d is mounted on the right side of the vehicle 10 and faces a target area to the right of the vehicle (i.e., the passenger side). It should be appreciated that the cameras 42 can be mounted at any suitable location, height, orientation, etc. and are not limited to the particular arrangement shown here. For example, the front camera 42a can be mounted on or behind a front bumper, grill or rear view mirror assembly; the rear camera 42b can be mounted on or embedded within a rear bumper, trunk lid, or license plate area; and the left and right cameras 42c, 42d can be mounted on or integrated within side mirror assemblies or doors, to cite a few possibilities. The location of the camera on the vehicle is referred to herein as a “camera location,” and each camera captures image data having a field-of-view, which is referred to herein as a “camera field-of-view.”

Each of the cameras 42 is associated with a camera field-of-view that captures a target area located outside of the vehicle 10. For example, as shown in FIG. 2, the front camera 42a captures image data of a target area that is in front of the vehicle and corresponds to a camera field-of-view partly defined by the azimuth angle cu. As another example, the left camera 42c captures image data of an area to the left of the vehicle that corresponds to a camera field-of-view partly defined by the azimuth angle α3. Part of the camera field-of-view of a first camera (e.g., the front camera 42a) may overlap with part of the camera field-of-view of a second camera (e.g., the left camera 42c). In one embodiment, the camera field-of-view of each camera overlaps with at least one camera field-of-view of another adjacent camera. For example, the camera field-of-view of the front camera 42a may overlap with the camera fields-of-view of the left camera 42c and/or the right camera 42d. These overlapping portions can then be used during the combining or stitching step of the first-person composite camera view generation process, as discussed below.

Vehicle sensors 44-48 provide the vehicle imaging system 12 with various types of sensor data that can be used to provide a first-person composite camera view. For instance, sensor 44 may be a transmission sensor that is part of a transmission control unit (TCU), an engine control unit (ECU), or some other vehicle device, unit and/or module, or it may be a stand-alone sensor. The transmission sensor 44 determines which gear the vehicle is presently in (e.g., neutral, park, reverse, drive, first gear, second gear, etc.), and provides the vehicle imaging system 12 with transmission data that is representative of the same. In one embodiment, the transmission sensor 44 sends transmission data to the vehicle video processing unit 22 via the communications bus 60, and the transmission data affects or influences the specific camera view shown to the driver. For instance, if the transmission sensor 44 sends transmission data that indicates the vehicle is in reverse, then the vehicle imaging system and method may display an image that includes image data from the rear camera 42b. In this example, the transmission data is acting as an “automatic camera view control input,” which is input that is automatically generated or determined by the vehicle electronics 20 based on one or more predetermined vehicle state(s) or operating condition(s).

The steering wheel sensor 46 is directly or indirectly coupled to a steering wheel of vehicle 10 (e.g., directly to a steering wheel or to some component in the steering column, etc.) and provides steering wheel data to the vehicle imaging system and method. Steering wheel data is representative of the state or condition of the steering wheel (e.g., steering wheel data may represent a steering wheel angle, an angle of one or more vehicle wheels with respect to a longitudinal axis of vehicle, a rate of change of such angles, or some other steering related parameter). In one example, the steering wheel sensor 46 sends steering wheel data to the vehicle video processing module 22 via the communications bus 60, and the steering wheel data acts as an automatic camera view control input.

Speed sensor 48 determines a speed, velocity and/or acceleration of the vehicle and provides such information in the form of speed data to the vehicle imaging system and method. The speed sensor 48 can include one or more of any number of suitable sensor(s) or component(s) commonly found on the vehicle, such as wheel speed sensors, global navigation satellite system (GNSS) receivers, vehicle speed sensors (VSS) (e.g., a VSS of an anti-lock braking system ABS)), etc. Furthermore, speed sensor 48 may be part of some other vehicle device, unit and/or module, or it may be a stand-alone sensor. In one embodiment, speed sensor 48 sends speed data to the vehicle video processing module 22 via the communications bus 60, where the speed data is a type of automatic camera view control input.

Vehicle electronics 20 also include a number of vehicle-user interfaces that provide occupants with a way of exchanging information (providing and/or receiving information) with the vehicle imaging system and method. For instance, the vehicle display 50 and the vehicle user interfaces 52, which can include any combination of pushbuttons, microphones, and audio systems, are examples of vehicle-user interfaces. As used herein, the term “vehicle-user interface” broadly includes any suitable form of electronic device, including both hardware and software, which enables a vehicle user to exchange information or data with the vehicle (e.g., provide information to and/or receive information from).

Display 50 is a vehicle-user interface and, in particular, is an electronic visual display that can be used to display various images, video and/or graphics, such as a first-person composite camera view. The display 50 can be a liquid crystal display (LCD), a plasma display, a light-emitting diode (LED) display, an organic LED (OLED) display, or other suitable electronic display, as appreciated by those skilled in the art. The display 50 may also be a touch-screen display that is capable of detecting a touch of a user such that the display acts as both an input and an output device. For example, the display 50 can be a resistive touch-screen, capacitive touch-screen, surface acoustic wave (SAW) touch-screen, an infrared touch-screen, or other suitable touch-screen display known to those skilled in the art. The display 50 can be mounted as a part of an instrument panel, as part of a center display, as part of an infotainment systems, as part of a rear view mirror assembly, as part of a heads-up-display reflected off of the windshield, or as part of some other vehicle device, unit, module, etc. According to a non-limiting example, the display 50 includes a touch screen, is part of a center display located between the driver and front passenger, and is coupled to the vehicle video processing module 22 such that it can receive display data from module 22.

With reference to FIG. 4, an embodiment is shown where the vehicle display 50 is being used to display a first-person composite camera view 202. The first-person composite camera view shows an image that is formed by combining image data from a plurality of cameras (“integrated” or “composite” image), where the image has a point-of-view of an observer located inside the vehicle (“first person”). The first-person composite camera view is designed to emulate or simulate the frame-of-reference of a person who is located inside the vehicle and is looking out and, in some embodiments, provides a user with a 360° view around the vehicle. According to the non-limiting example shown in FIG. 4, the first-person composite camera view 202 is displayed in a first portion 200 of the display 50, and includes augmented graphics 204 that are overlaid, superimposed and/or otherwise combined with composite image data 206. In one embodiment, the augmented graphics 204 provide the driver with intuitive information or settings regarding the frame-of-reference of the first-person composite camera view 204. The augmented graphics 204 may include computer-generated representations of portions of the vehicle that would normally be seen by an observer, if that observer was located in the vehicle and looking out in that particular direction. For example, the augmented graphics 204 may include portions of: a vehicle hood when the first-person composite camera view is a forward-facing view (see FIG. 4), a vehicle trunk lid when the first-person composite camera view is a rearward-facing view, a dashboard or A-pillar when the first-person composite camera view is a forward-facing view, an A- or B-pillar when the first-person composite camera view is a side-facing view, and so on.

The display 50 also includes a second portion 210 that provides the user with a direction indicator 214, as well as other camera view controls that enable the user to manually engage and/or control certain aspects of the first-person composite camera view 202. In FIG. 4, the second portion 210 displays a virtual vehicle 212 and the direction indicator 214 superimposed thereon. Graphics representative of the virtual vehicle 212 may be saved at some appropriate location in vehicle electronics 20 and, in some instances, may be designed to resemble the actual vehicle 10. The virtual background 216 of the second portion 210 surrounds the virtual vehicle 212 and can be rendered based on actual image data from the cameras 42 or can be a default background, for example. In those embodiments where display 50 is a touch-screen, a user can control the direction of the first-person composite camera view 202 by engaging and rotating the direction indicator 214. For example, the user can touch the direction indicator 214 located on the second portion 210 of the display and drag or swing their finger around the circle in a clockwise or counter-clockwise direction, thereby changing the corresponding camera direction shown in the first-person composite camera view 202 located on the first portion 200. In this way, the user is able to manually engage and take over control of the display such that that the second portion 210 acts as an input device to receive information from the user and the first portion 200 acts as an output device to provide information to the user. In a different embodiment, the user can zoom in on a particular area or point of interest by pressing on the direction indicator 214 and holding it in a fixed position. This may cause the relevant cameras to zoom in the direction selected by the user (e.g., the longer the direction indicator is pressed, the greater the zoom, subject to camera capabilities). It is possible for the selected viewing angle to remain active while the user's finger is raised and until, for example, an additional tap or press by the user causes the cameras to zoom out. Other embodiments and examples are certainly possible.

In some embodiments, the display 50 may be divided or separated such that the first portion 200 is positioned at a different location than the second portion 210 (as opposed to being located on different sides of the same display, as shown in FIG. 4). For example, it is possible for the second portion 210 to be presented on another display of the vehicle 10, or for the second portion 210 to be omitted altogether. In other embodiments, different types of direction indicators or input techniques can be used for controlling the direction of the first-person composite camera view. For example, the display could be configured for a user to swipe their finger from left to right along the first and/or second portions 200, 210 so that the direction of the first-person composite camera view is correspondingly changed from left to right as well. In yet another embodiment, vehicle-user interfaces 52 (e.g., knobs, controls, sliders, arrows, etc.) can be used to control the direction of the first-person composite camera view. Input provided from a user to the vehicle imaging system 12 for controlling some aspect of the first-person composite camera view (e.g., input provided by the user via the direction indicator 214) is referred to herein as “manual camera view control input,” and is a type of camera view control input.

The vehicle electronics 20 includes other vehicle user interfaces 52, which can include any combination of hardware and/or software pushbutton(s), control(s), microphone(s), audio system(s), menu option(s), to name a few. A pushbutton or control can allow manual user input to the vehicle imaging system 12 for purposes of providing the user with the ability to control some aspect of the system (e.g., manual camera view control input). An audio system can be used to provide audio output to a user and can be a dedicated, stand-alone system or part of the primary vehicle audio system. One or more microphone(s) can be used to provide audio input to the vehicle imaging system 12 for purposes of enabling the driver or other occupant to provide voice commands. For this purpose, it can be connected to an on-board automated voice processing unit utilizing human-machine interface (HMI) technology known in the art and, thus, function as a manual camera view control input. Although the display 50 and the other vehicle-user interfaces 52 are depicted as being directly connected to the vehicle video processing module 22, in other embodiments, these items are indirectly connected to module 22, a part of other devices, units, modules, etc. in the vehicle electronics 20, or are provided according to other arrangements.

According to various embodiments, any one or more of the processors discussed herein (e.g., processor 24, another processor of the video processing module 22 or of the vehicle electronics 20) may be any type of device capable of processing electronic instructions including microprocessors, microcontrollers, host processors, controllers, vehicle communication processors, a General Processing Unit, accelerators, Field Programmable Gated Arrays (FPGA), and Application Specific Integrated Circuits (ASICs), to cite a few possibilities. The processor can execute various types of electronic instructions, such as software and/or firmware programs stored in memory, which enable the module to carry out various functionality. According to various embodiments, any one or more of the memory discussed herein (e.g., memory 26) can be a non-transitory computer-readable medium; these include different types of random-access memory (RAM), including various types of dynamic RAM (DRAM) and static RAM (SRAM)), read-only memory (ROM), solid-state drives (SSDs) (including other solid-state storage such as solid state hybrid drives (SSHDs)), hard disk drives (HDDs), magnetic or optical disc drives, or other suitable computer medium that electronically stores information. Moreover, although certain devices or components of the vehicle electronics 20 may be described as including a processor and/or memory, the processor and/or memory of such devices or components may be shared with other devices or components and/or housed in (or be a part of) other devices or components of the vehicle electronics 20. For instance, any of these processors or memory can be a dedicated processor or memory used only for a particular module or can be shared with other vehicle systems, modules, devices, components, etc.

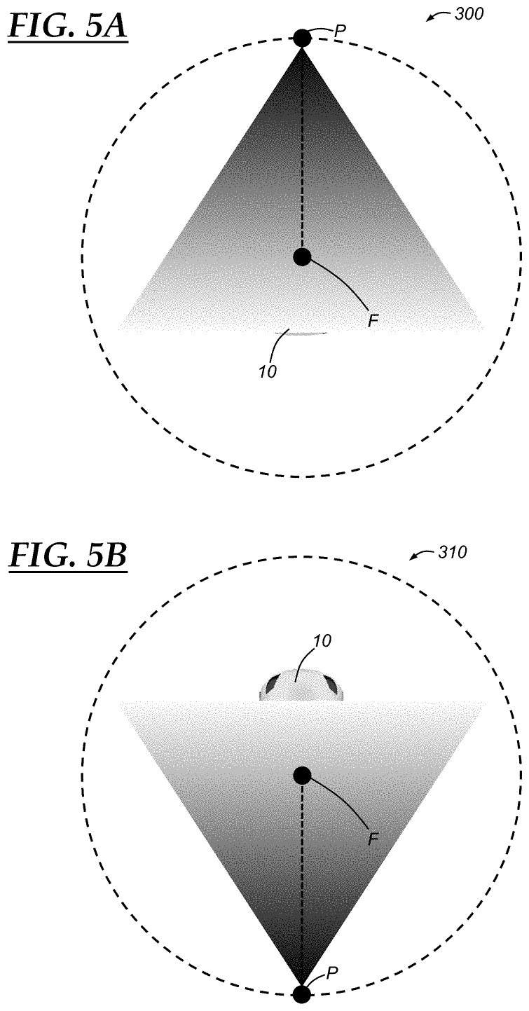

With reference to FIGS. 5A and 5B, holistic or third-person camera views 300, 310 (also referred to as bowl views) are illustrated in which the point-of-view P is located outside of the vehicle 10. The focus F (i.e., the center of the camera field-of-view) of the third-person camera view 300, 310 remains toward the vehicle 10 in these examples. The point-of-view P corresponds to the location of an observer from which the third-person camera view is taken. FIG. 5A depicts a rearward-facing third-person camera view 300 that is taken from a location in which the observer (or point-of-view P) is located in front of the vehicle with the focus F being backwards towards the vehicle. This rearward-facing third-person camera view is used by some conventional parking solutions when the vehicle is being operated in reverse. However, the presence of the vehicle itself within the third-person camera view obstructs some of the areas directly behind the vehicle 10. FIG. 5B depicts a forward-facing third-person camera view 310 that is taken from a location in which the observer (or point-of-view P) is located behind the vehicle with the focus F being forwards, towards the vehicle. The forward-facing third-person camera view 310 includes the vehicle 10, which obstructs viewing an area directly in front of the vehicle. In some instances, the third-person or holistic camera views of FIGS. 5A and 5B are referred to as a “bowl view.” The dotted circle illustrates the potential locations of the point-of-view P for the third-person camera, as the point-of-view changes when the view is rotated around the vehicle.

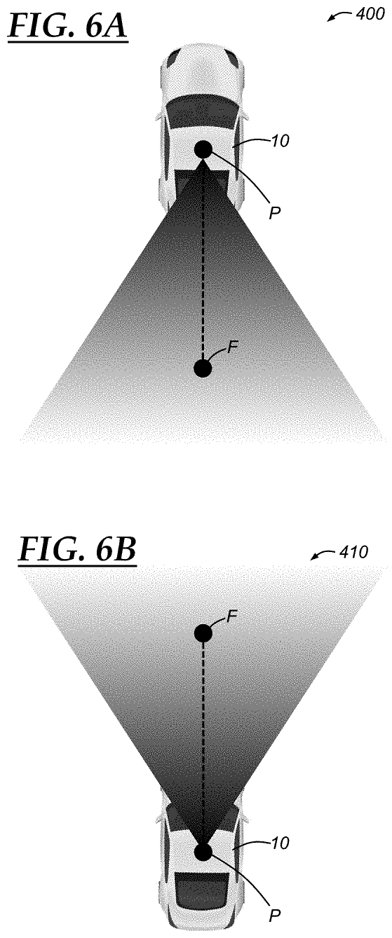

With reference to FIGS. 6A and 6B, first-person camera views 400, 410 are illustrated in which the point-of-view P is generally stationary and located within the vehicle 10. According to the illustrated embodiments, the location of the point-of-view P generally does not move when the direction of the first-person camera view is changed—that is, the location of the point-of-view P is substantially the same for both the rearward-facing first-person camera view 400 (FIG. 6A) and the forward-facing first-person camera view 410 (FIG. 6B), for example. It should be appreciated that, in some embodiments, the location of the point-of-view P of the first-person camera view may move slightly when the direction of the camera view changes; however, the location of the point-of-view P remains within the vehicle (this is what is meant by “generally” or “substantially” stationary).

In one embodiment, the vehicle imaging system 12 can be used to generate and display a first-person composite camera view. As discussed above, FIG. 4 illustrates one potential first-person composite camera view 202, which corresponds to the forward-facing first-person camera view 410 of FIG. 6B. In at least some embodiments, a first-person composite camera view can be generated based on image data from a plurality of cameras 42 that have a field-of-view of an area that is substantially located outside of the vehicle. As will be explained in more detail below, image data from a plurality of cameras can be combined (e.g., stitched together) to form a single first-person composite camera view. Also, through image processing techniques, the image data can be transformed and combined so that the first-person composite camera view emulates or simulates a view of an observer located within the vehicle. Since the cameras may be mounted on or near the exterior of the vehicle, the captured image data from the cameras may not include any portions of the vehicle itself. However, augmented graphics can be overlaid or otherwise added to the first-person composite camera view so that the vehicle user is provided intuitive information concerning the frame-of-reference or point-of-view direction and location of which the first-person composite camera view is simulating. For example, when the first-person composite camera view is a forward-facing view (as in FIGS. 4, 6B), an augmented graphic of a portion of the hood, the front windshield frame, etc. can be overlaid at the bottom of the first-person composite camera view so as to emulate or simulate an actual view where a user is looking out of the front window. However, other portions of the vehicle that would likely be visible to an observer at the point-of-view of the first-person composite camera view may be omitted so as to not obstruct viewing of areas outside of the vehicle.

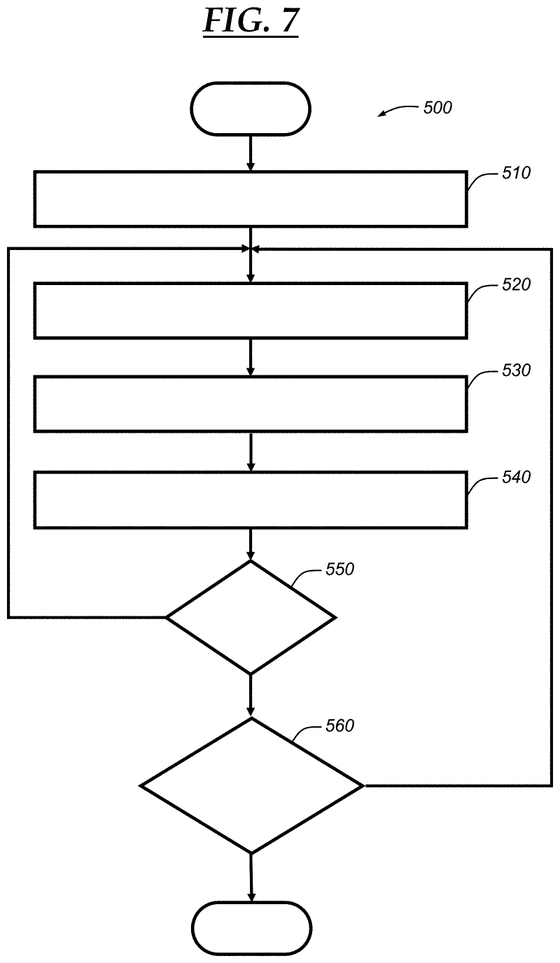

With reference to FIG. 7, there is shown a flowchart illustrating an embodiment of a vehicle imaging method 500 for displaying a first-person composite camera view. In at least some embodiments, the method 500 is carried out by the vehicle imaging system 12, which can include the video processing module 22, the plurality of cameras 42, and the display 50. As mentioned above, the vehicle imaging system 12 can include other components or portions of the vehicle electronics 20, such as the transmission sensor 44, the steering wheel sensor 46, and the speed sensor 48. Although the steps of the method 500 are described as being carried out in a particular order, it is contemplated that the steps of the method 500 can be carried out in any suitable or technically-feasible order as will be appreciated by those skilled in the art.

Beginning with step 510, the method receives an indication or signal to initiate the first-person composite camera view. This indication may be received automatically based on the operation of the vehicle, or it may be received manually from a user via some type of vehicle-user interface. For instance, when the vehicle is put in reverse, the transmission sensor 44 may automatically send transmission data to the vehicle video processing module 22 that causes it to initiate the first-person composite camera view so that it can be displayed to the driver. In a different example, a user may manually press a touch screen portion of the display 50, manually engage a vehicle user interface 52 (e.g., a “Show Camera View” button), or manually speak a command that is picked up by a microphone 52 such that the method initiates the process of displaying a first-person composite camera view, to cite several possibilities. Once this step is complete, the method may proceed.

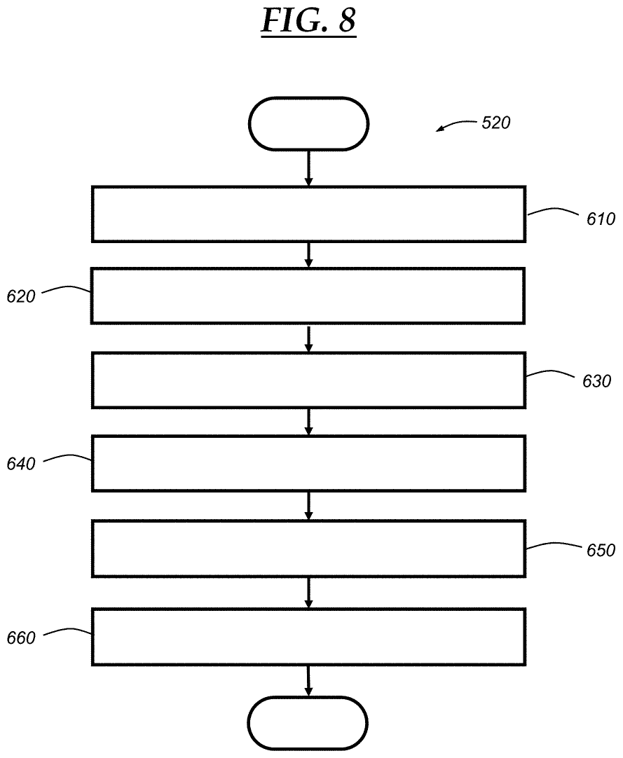

In step 520, the method generates and/or updates the first-person composite camera view. The first-person composite camera view may be generated from image data gathered from multiple vehicle cameras 42, as well as corresponding camera location and orientation data for each of the cameras. The camera location and orientation data provides the method with information regarding the mounting locations, alignments, orientations, etc. of the cameras so that image data captured by each of the cameras can be properly and accurately combined (e.g., stitched together) in the form of composite image data. In one embodiment, the first-person composite camera view is generated using the process of FIG. 8, which is discussed below, but other processes may be used instead.

In some instances, such as when the method has just been initiated in step 510, the first-person composite camera view may need to be generated from scratch. In other instances, such as when the method has been running and has already generated a first-person composite camera view, step 520 may need to refresh or update the images of that view; this is illustrated in FIG. 7 when the method loops back to step 520 from step 550. In such circumstances, an updated first-person composite camera view is generated, which can include carrying out the first-person composite camera view generation process of FIG. 8 for new image data or a new camera direction. The method may then continue to step 530.

In step 530, the method adds augmented graphics to the first-person composite camera view. The augmented graphics can include or depict various portions of the vehicle, as described above, so as to provide the user with intuitive information concerning the point-of-view, the direction, or some other aspect of the first-person composite camera view. Information concerning these augmented graphics can be stored in memory (e.g., memory 26) and then recalled and used to generate and overlay the graphics onto the first-person composite camera view. In one embodiment, the augmented graphics are electronically associated with or fixed to a particular object or location within the first-person composite camera view so that, when the direction of the first-person composite camera view is changed, the augmented graphics change as well so that they appear to naturally move along with the changing images. Step 530 is optional, as it is possible to provide a first-person composite camera view without augmented graphics. The method 500 continues to step 540.

With reference to step 540, the method displays or otherwise presents the first-person composite camera view at the vehicle. According to one possibility, the first-person composite camera view is generally shown on display 50 as a live video or video feed, and is based on contemporaneous image data being gathered from the plurality of cameras 42 in real time or nearly real time. New image data is consistently being gathered from the cameras 42 and is used to update the first-person composite camera view so that it depicts live conditions as the vehicle is being reversed, for example. Skilled artisans will appreciate that numerous methods and techniques exist for gathering, blending, stitching, or otherwise joining image data from video cameras, and that any of which may be used here. The method 500 then continues to step 550.

In step 550, the method determines if a user has initiated some type of manual override. To illustrate, consider the example where a user initially put the vehicle in reverse, thereby initiating the first-person composite camera view in step 510, so that automatic camera view control input from the steering wheel sensor 46 dictates the direction of the camera view (e.g., as the user reverses the vehicle and turns the steering wheel, the direction of the first-person composite camera view shown in vehicle display 50 correspondingly changes). If, during this process, the user engages the touch screen and uses his or her finger to rotate the direction indicator 214, the output from the touch screen constitutes manual camera view control input and informs the system that the user wishes to manually override the direction of the camera view. In this way, step 550 provides the user with the option of overriding the automatically determined direction of the first-person composite camera view in the event that the user wishes to explore the area around the vehicle. Of course, the actual method of manually overriding or interrupting the software to accommodate the user can be carried out in any number of different ways and is not limited to the schematic illustration shown in FIG. 7. If step 550 receives manual camera view control input from display 50 (i.e., a manual override signal initiated by the user), then the method loops back to step 520 so that a new first-person composite camera view can be generated according to the direction dictated by the direction indicator 214 or some other user input. Skilled artisans will appreciate that a smooth reverse between views may be needed to minimize discomfort to the user, where the direction may be based on the smaller angle formed by the user's input or the reverse direction to the user's input. If step 550 does not detect any attempt by the user to manually override the camera view, then the method continues.

Step 560 determines if the method should continue to display the first-person composite camera view or if the method should end. One way to determine this is through the use of the camera view control inputs. For example, if the method continues to receive camera view control input (thus, indicating that the method should continue displaying the first-person composite camera view), then the method may loop back to step 520 so that images can continue to be generated and/or updated. If the method does not receive any new camera view control input or any other information indicating that the user wishes to continue viewing the first-person composite camera view, then the method may end. As indicated above, there are two types of camera view control input: automatic camera view control input and manual camera view control input. The automatic camera view control input is input that is automatically generated or sent by the vehicle electronics 20 based on predetermined vehicle states or operating conditions. For example, if the transmission data from the transmission sensor 44 indicates that the vehicle is no longer in reverse, but instead is in park, neutral, drive, etc., then step 550 may decide that the first-person composite camera view is no longer needed, as it is generally used as a parking solution. In a different example, if a user engages a touch screen showing the direction indicator 214 and manually rotates or manipulates that control (an example of a manual camera view control input), step 550 may interpret this to mean that the user wishes to continue viewing the first-person composite camera view so that the method loops back to step 520, even if the vehicle is in park (although in most embodiments, changing gear following a user's input will typically supersede the user's input, although this is not required). In yet another example, the user may specifically instruct the vehicle to cease displaying the first-person composite camera view by selecting an “End Camera View” option, by engaging a corresponding button on the display 50, or simply by verbally stating such a command to the HMI. The method may continue in this way until an indication to stop displaying the first-person composite camera view is received (or a lack of camera view control inputs are received), at which point the method may end.

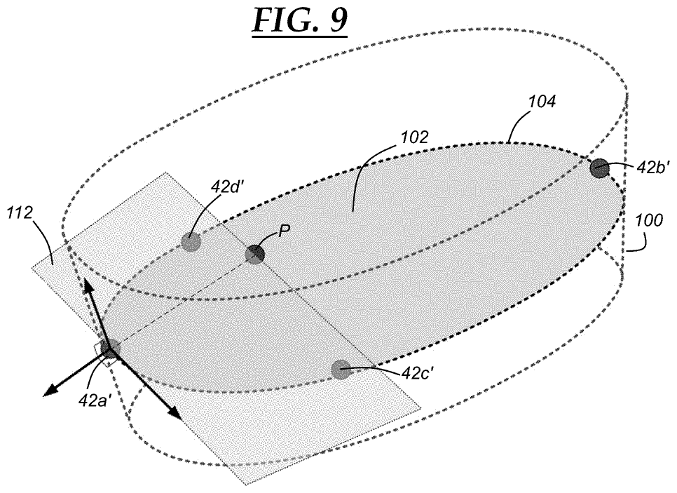

With reference to FIG. 8, there is shown a non-limiting embodiment of a first-person composite camera view generation process. This process can be carried out as step 520 in FIG. 7, as a part of step 520, or according to some other arrangement and represents one possible way of generating, updating and/or otherwise providing a first-person composite camera view. Although the steps of the process are described as being carried out in a particular order, it is contemplated that the steps of the process can be carried out in any suitable or technically-feasible order, and that the process may include a different combination of steps as shown here. The following process is described in conjunction with FIGS. 3 and 9, and it is assumed that there are four outward-looking cameras, such as cameras 42a-d, although other camera configurations are certainly possible.

As a first potential step in process 520, the method mathematically builds a projection manifold 100, on which the first-person composite camera view can be projected or presented, step 610. As illustrated in FIG. 9, the projection manifold 100 is a virtual object that has an elliptical- or oval-shaped cylindrical form and is at least partially defined by a camera plane 102, a camera ellipse 104 and a point-of-view P. The camera plane 102 is a plane that passes through the plurality of camera locations. In some instances, it may not be possible to fit all of the plurality of cameras 42a-d to a single plane and, in such cases, a best effort fitting approach can be used. In such embodiments, the best effort fitting approach may favor allowing vertical errors over horizontal errors to reduce, for example, possible horizontal motion parallax.

Once the camera plane 102 has been defined, a camera ellipse 104 that resides on the camera plane 102 (i.e., the camera ellipse and camera plane are coplanar) is defined and has a boundary that corresponds to the locations of the plurality of cameras 42a-d, as illustrated in FIG. 9. Again, it may not be possible to exactly fit the camera ellipse 104 on the camera plane 102 so that it precisely extends through each of the actual camera locations and, in such instances, a best effort fitting approach can be used to select locations closest to the actual camera locations. In doing so, effective camera locations 42a′-d′ are selected for each of the plurality of cameras 42a-d, where the effective camera locations reside along the perimeter of the camera ellipse 104, as shown in FIGS. 3 and 9.

The point-of-view P of the first-person composite camera view may be defined or selected so that it is on the camera plane 102 and is within the camera ellipse 104 (see FIG. 9). In one embodiment, the point-of-view P of the first-person composite camera view is located at an intersection of projecting lines 110a-d, where each projecting line is perpendicular to a line tangent to the camera ellipse perimeter at a certain effective camera location (see FIG. 3). Put differently, if one was to draw a projecting line 110a-d at each of the effective camera locations 42a′-d′, where each projecting line is perpendicular or orthogonal to a line tangent to the ellipse perimeter at that location, then the various projecting lines 110a-d would intersect at the point-of-view location P, as shown in FIG. 3. In this embodiment, the projection manifold 100 has a curved surface that is perpendicular or orthogonal to the camera plane 102, the projection manifold 100 is locally tangent to the camera ellipse 104, and the point-of-view P is located on the same camera plane 102 as the camera ellipse 104.

In other embodiments, the point-of-view P of the first-person composite camera view may be selected to be above or below the camera plane 102, for example, to accommodate a taller or shorter user (the point-of-view may be adjusted up or down from the camera plane 102 to the expected height of the eyes of the user, so as to better mimic what the driver would actually see). In such an example, a pseudo-conical surface is defined (not shown) as including the point-of-view P at its apex or vertex and the camera ellipse 104 along its flat base. The projection manifold may be built such that it contains the camera ellipse 104 and that, at each point along the perimeter of the camera ellipse 104, the projection manifold is locally perpendicular to the pseudo-conical surface that is formed. In this example, the projection manifold is locally perpendicular to a local tangent plane, which is a plane that tangentially corresponds to the pseudo-conical surface discussed above.

Once the point-of-view location has been determined, it may be stored in memory 26 or elsewhere for subsequent retrieval and use. For instance, following an initial completion of step 610, the camera plane, camera ellipse and/or point-of-view location information can be stored in memory and subsequently retrieved the next time process 520 is performed so that processing resources can be preserved.

In step 620, the process estimates a rotation matrix used for image transformation into the projection frame-of-reference (FOR). For each camera location (or effective camera location 42a′-d′), a local orthonormal basis 112 may be defined, as shown in FIG. 9. Since the orientation of each vehicle camera 42a-d with respect to the vehicle frame-of-reference is known (e.g., such information can be stored in the camera location and orientation data), a rotation matrix R_{cp} between the original and the projection frame-of-reference can be estimated as: R_{cp}=R_{c}Rₚ^{T}, where Rₚ is the projection frame-of-reference and is calculated as a direction cosine matrix (DCM), and where R_{c} is the original frame-of-reference.

Next, step 630 obtains image data from each of the vehicle cameras. The processing of obtaining or retrieving image data from the various vehicle cameras 42a-d may be carried out in any number of different ways. In one example, each of the cameras 42 uses its frame grabber to extract frames of image data, which can then be sent to the vehicle video processing module 22 via the communications bus 60, although the image data may be gathered by other devices in other ways at other points in the process. In some embodiments, the direction of the point-of-view of the first-person composite camera view can be obtained or determined and, based on this direction, only certain cameras may capture image data and/or send the image data to the video processing module. For example, when the direction of the point-of-view of the first-person composite camera view is rearward, the first-person composite camera view may not need any image data from the front camera 42a and, thus, this camera 42a may forgo capturing image data at this time. Or, in another embodiment, image data may be captured by this camera 42a, but not sent to the video processing module 22 (or otherwise not used in the current iteration of the first-person composite camera view generation process)

Once the image data is obtained from the vehicle cameras, step 640 transforms the image data to the corresponding frame-of-reference of the projection manifold. Stated differently, now that a projection manifold has been mathematically built (step 610) and the individual orientation of each of the vehicle cameras has been taken into account (step 620), the process may transform or otherwise modify the images from each of the vehicle cameras 42a-d from their initial state to a state where they are projected on the projection manifold (step 640). The transformation for a pinhole camera, for example, has a form of a Rotation Homography as follows:

$$( \begin{matrix}{u}_{p} \\ {v}_{p} \\ 1\end{matrix} ) = {H}_{cp} ( \begin{matrix}u \\ v \\ 1\end{matrix} ) = {KR}_{cp} {K}^{- 1} ( \begin{matrix}u \\ v \\ 1\end{matrix} )$$

where K is the intrinsic calibration matrix, u is the initial horizontal image (pixel) coordinate, v is the initial vertical image (pixel) coordinate, uₚ is the transformed horizontal image (pixel) coordinate, vₚ is the transformed vertical image (pixel) coordinate, and H_{cp} is the actual Rotation Homography matrix. As those skilled in the art will appreciate, for different types of cameras (e.g., a fisheye camera), the transformation may be different.

Step 650 then rectifies each transformed image along the local tangent of the camera ellipse. For example, for pinhole cameras, the transformed image can be rectified along the local tangent to the camera ellipse 104 by undistorting the transformed image (this is why projected images oftentimes appear undistorted or have minimal distortion towards the horizontal center of the image). For fisheye cameras, the process may rectify the transformed images by projecting the transformed image onto the elliptical- or oval-shaped cylindrical surface of the projection manifold 100. In this way, the transformed image data is rectified in a direction looking from the point-of-view P.

Then, once the image data has been transformed and rectified, the resulting transformed-rectified image data from the different vehicle cameras may be stitched together or otherwise combined to form a composite image, step 660. An exemplary combining/stitching process can include an overlapping region estimation technique and a blending technique. For the overlapping estimation technique, overlapping regions of the transformed-rectified image data are estimated or identified based on the known locations and orientations of the cameras, which can be stored as a part of the camera location and orientation data. For the blending technique, straightforward a-blending between the overlapping regions may create “ghosts” (at least in some scenarios) and, thus, it may be desirable to use a context-dependent stitching or combining technique, such as a block-matching with subsequent local warping technique, or a multi-perspective plane sweep technique.

In some embodiments, depth or range information regarding objects within one or more of the camera's field-of-view can be obtained, such as through use of the cameras, or other sensors of the vehicle (e.g., radar, lidar). In one embodiment where the depth or range information is obtained, the image data can be virtually translated to the point-of-view P of the first-person composite camera view after corresponding image warping is performed to compensate for the perspective change. Then, the transforming step can be carried out in which the virtually translated image data from each of the cameras is related through transformation (e.g., Rotation Homography), and then the combining step is carried out to form the first-person composite camera view. In such an embodiment, the influence of motion parallax with respect to the combining step may be reduced or negligible.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “e.g.,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation. In addition, the term “and/or” is to be construed as an inclusive or. As an example, the phrase “A, B, and/or C” includes: “A”; “B”; “C”; “A and B”; “A and C”; “B and C”; and “A, B, and C.”

What is claimed is:

1. A vehicle imaging method for use with a vehicle imaging system, the vehicle imaging method comprising the steps of:
obtaining image data from a plurality of vehicle cameras;
generating a first-person composite camera view based on the image data from the plurality of vehicle cameras, the first-person composite camera view is formed by combining the image data from the plurality of vehicle cameras and presenting the combined image data from a point-of-view of an observer located within the vehicle; and
displaying the first-person composite camera view on a vehicle display.

2. The vehicle imaging method of claim 1, wherein the generating step further comprises generating the first-person composite camera view that includes augmented graphics combined with composite image data.

3. The vehicle imaging method of claim 2, wherein the augmented graphics include computer-generated representations of portions of the vehicle that would normally be seen by the observer located within the vehicle if the observer was looking out of the vehicle in a particular direction, the composite image data includes the combined image data from the plurality of vehicle cameras, and the augmented graphics are superimposed on the composite image data.

4. The vehicle imaging method of claim 3, wherein the computer-generated representations of portions of the vehicle are electronically associated with a particular object or location within the first-person composite camera view so that, when the particular direction of the perspective of the observer is changed, the augmented graphics change as well so that they appear to naturally move along with the changing composite image data.

5. The vehicle imaging method of claim 3, wherein when the first-person composite camera view is a rearward facing view, the augmented graphics include computer-generated representations of a portion of a vehicle trunk lid, of a portion of a vehicle rear window frame, or both.

6. The vehicle imaging method of claim 1, wherein the generating step further comprises presenting the combined image data from a substantially stationary point-of-view of the observer located within the vehicle, the substantially stationary point-of-view is still located within the vehicle even when a direction of the first-person camera view is changed.

7. The vehicle imaging method of claim 1, wherein the generating step further comprises generating the first-person composite camera view so that a user has a 360° view around the vehicle.

8. The vehicle imaging method of claim 1, wherein the generating step further comprises generating the first-person composite camera view in response to a camera view control input.

9. The vehicle imaging method of claim 1, wherein the generating step further comprises building a projection manifold on which the first-person composite camera view can be displayed, and the projection manifold is a virtual object that is at least partially defined by a camera plane, a camera ellipse, and a point-of-view of the observer located within the vehicle.

10. The vehicle imaging method of claim 9, wherein the camera plane is a virtual plane corresponding to the locations of the plurality of vehicle cameras, and for each of the plurality of vehicle cameras, the camera plane either passes through an actual location of the vehicle camera or an effective location of the vehicle camera.

11. The vehicle imaging method of claim 9, wherein the camera ellipse is a virtual ellipse corresponding to the locations of the plurality of vehicle cameras and being coplanar with the camera plane, and for each of the plurality of vehicle cameras, the camera ellipse either passes through an actual location of the vehicle camera or an effective location of the vehicle camera.

12. The vehicle imaging method of claim 9, wherein the location of the point-of-view of the observer is on the camera plane and is within the camera ellipse.

13. The vehicle imaging method of claim 12, wherein the location of the point-of-view of the observer corresponds to an intersection of a plurality of projecting lines, and each of the plurality of projecting lines is perpendicular to a line tangent to a perimeter of the camera ellipse at the actual location of the vehicle camera or the effective location of the vehicle camera.

14. The vehicle imaging method of claim 9, wherein the location of the point-of-view of the observer is above or below the camera plane, is within the camera ellipse, and corresponds to an apex of a pseudo-conical surface that includes the camera ellipse along a flat base.

15. The vehicle imaging method of claim 9, wherein the generating step further comprises transforming the image data from the plurality of vehicle cameras to a corresponding frame-of-reference of the projection manifold.

16. The vehicle imaging method of claim 15, wherein the generating step further comprises rectifying the transformed image data along a local tangent of the camera ellipse.

17. The vehicle imaging method of claim 16, wherein the generating step further comprises stitching together the transformed-rectified image data to form the composite camera view.

18. The vehicle imaging method of claim 1, wherein the displaying step further comprises displaying the first-person composite camera view on a first portion of the vehicle display and a direction indicator on a second portion of the vehicle display, the direction indicator enables a user to manually engage or control certain aspects of the first-person composite camera view.

19. The vehicle imaging method of claim 18, wherein the direction indicator is superimposed on a virtual vehicle and is displayed a touch-screen that is part of the second portion of the vehicle display, the direction indicator is electronically linked to the first-person composite camera view such that when the user manually engages the direction indicator via the touch screen, a direction of the first-person composite camera view changes accordingly.

20. A vehicle imaging system, comprising:
a plurality of vehicle cameras that provide image data;
a vehicle video processing module coupled to the plurality of vehicle cameras, wherein the vehicle video processing module is configured to generate a first-person composite camera view based on the image data from the plurality of vehicle cameras, the first-person composite camera view is formed by combining the image data from the plurality of vehicle cameras and presenting the combined image data from a point-of-view of an observer located within the vehicle; and
a vehicle display coupled to the vehicle video processing module for displaying the first-person composite camera view.
